(19) United States
(12) Patent Application Publication
(10) Pub. No.: US 2026/0336528 A1
(43) Pub. Date: Oct. 29, 2026

(54) MULTIPURPOSE MODULE FOR A MOBILITY VEHICLE

(71) Applicants: HYUNDAI MOTOR COMPANY, Seoul (KR); KIA CORPORATION, Seoul (KR); KWANG MYUNG IND. CO., LTD., Gwangmyeong-si (KR); HYUNDAI TRANSYS INC., Seosan-si (KR)

(72) Inventors: Jung Hoon Woo, Hwaseong-si (KR); Ji Yun Ha, Hwaseong-si (KR); Soo Bok Kim, Hwaseong-si (KR); Byung Hoon Yoo, Seongnam-si (KR); Min Ho Kang, Hwaseong-si (KR); Tae Hun Cheon, Seongnam-si (KR); Jong Seon Lee, Hwaseong-si (KR); Jae Yong Jang, Suwon-si (KR); Ki Young Yun, Yongin-si (KR); In Gul Baek, Yongin-si (KR); Kook Hee Lee, Suwon-si (KR)

(73) Assignees: HYUNDAI MOTOR COMPANY, Seoul (KR); KIA CORPORATION, Seoul (KR); KWANG MYUNG IND. CO., LTD., Gwangmyeong-si (KR); HYUNDAI TRANSYS INC., Seosan-si (KR)

(21) Appl. No.: 19/386,949

(22) Filed: Nov. 12, 2025

(30) Foreign Application Priority Data
Apr. 29, 2025 (KR) 10-2025-0056450

(51) Int. Cl. B60R 11/00; B60N 2/07; B62D 25/20

(52) U.S. Cl. CPC B60R 11/00; B62D 25/20; B60N 2/0722; B60R 2011/0029; B60R 2011/0045; B60R 2011/0084

(57) ABSTRACT

A multipurpose module for a mobility vehicle is configured to change the position of an auxiliary device such as a seat or stand in the interior of a mobility vehicle to various positions along path parts. In this way, the convenience of using the auxiliary device is improved, and the marketability of the mobility is enhanced as the usability of the interior space is increased by allowing passengers to freely change the interior space of the mobility vehicle.

### CROSS REFERENCE TO RELATED APPLICATIONS

The present application claims the benefit of and priority to Korean Patent Application No. 10-2025-0056450, filed Apr. 29, 2025, the entire contents of which is incorporated herein for all purposes by this reference.

### TECHNICAL FIELD

The present disclosure relates to a multipurpose module for mobility vehicles, which can change the position of an auxiliary device such as a seat or a stand to various positions in the interior of a mobility vehicle.

### BACKGROUND

Mobility vehicles that move while carrying passengers are equipped with a variety of auxiliary devices such as seats for passengers to sit on, stands, and armrests to enhance passenger convenience.

In addition, in the case of a large mobility vehicle, as the number of passengers increase, the number of seats, stands, and armrests may increase, and various other convenience devices may be applied.

Conventionally, convenience devices including seats are fixed in their originally designed positions. As a result, the interior space of a mobility vehicle is limited, and passengers may experience inconvenience in using each convenience device.

The description provided above as background art of the present disclosure is just for helping understand the background of the present disclosure and should not be construed as being included in the related art known by those having ordinary skill in the art.

### SUMMARY

An objective of the present disclosure is to provide a multipurpose module for a mobility vehicle, which enables the position of an auxiliary device such as a seat or stand to be changed to various positions inside the mobility vehicle, thereby improving the convenience of passengers and the marketability of the mobility vehicle.

The objectives of the present disclosure are not limited to those mentioned above. Other objectives not explicitly stated should be apparent to those of ordinary skill in the relevant technical field from the description below.

In order to achieve the objectives of the present disclosure, there is provided a multipurpose module for mobility vehicles, the module including: a rail constructed such that a plurality of path parts intersects at least at one point on the floor; and a movable member on which an auxiliary device is installed or disposed, the movable member configured to be movable along the path parts, thereby changing the position of the auxiliary device by moving along each of the path parts while passing through an intersection point of the path parts.

As an embodiment, the rail may include: a first path part extending in one (first) direction; and a second path part extending in a (second) direction orthogonal to the first path part and configured to intersect the first path part at the one point on the floor.

As an embodiment, the movable member may include: a body part in or on which the auxiliary device is installed or disposed; and a rolling part configured to be rotatable in at least one direction at a lower portion of the body part.

As an embodiment, the body part may be provided with a mounting part that extends upwardly from the body part to be exposed from the rail, and the auxiliary device may be detachably installed on the mounting part.

As an embodiment, in the lower portion of the body part, a recessed groove part may be formed to extend in a direction in which one of the path parts extends, and the rolling part may be formed in a cylindrical shape and be secured in the groove part to support the body part from the floor.

As an embodiment, the groove part may extend in the direction in which the one of the path parts extends, and the rolling part may be seated in the groove part so that the rolling part slides when the body part moves along the one of the path parts and rolls when the body part moves along another of the path parts.

As an embodiment, a bearing part may be provided in the groove part, and the rolling part may be rotatably seated in the groove part via the bearing part.

As an embodiment, a portion of the groove part may protrude inward to form a fixing part, and the bearing part may be fitted into the fixing part with an outer surface thereof in contact with the groove part, and an inner surface thereof may be formed so that the rolling part is insertable therein.

As an embodiment, the bearing part may be formed to be curved along an inner surface of the groove part, and a portion of an inner surface of the bearing part may form a circle (or at least be semi-circular), and the rolling part may include a contact part that comes into contact with the inner surface of the bearing part and a support part that extends from the contact part in a longitudinal direction of the groove part and is supported on the floor.

As an embodiment, the rolling part may include a ball bearing, and a portion thereof may be inserted into the lower portion of the body part to rotatably support the body part from the floor.

As an embodiment, the each of the path parts may include a pair of wall parts, and the wall parts may form a path through which the movable member can move.

As an embodiment, the movable member may be provided with a plurality of damping parts on a peripheral surface thereof, and at least one damping part may come into contact with one of the wall parts of the each of the path parts.

As an embodiment, the movable member may be provided with a plurality of fastening parts along the peripheral surface thereof, and the damping parts may be respectively mounted on the fastening parts, and a portion of each of the damping parts that comes into contact with the one of the wall parts may be made to be elastically deformable.

As an embodiment, a catch part protruding along a path of the movable member may be provided on each of the wall parts of the each of the path parts, and a plurality of anti-separation parts may be provided on a peripheral surface of the movable member, so that at least one anti-separation part is matched with the catch part.

As an embodiment, the catch part may have a shape that is bent downward from the each of the wall parts, and each of the anti-separation parts may have a shape that extends from the movable member to below the catch part and then bends upward.

As an embodiment, a plurality of fixing grooves may be arranged spaced apart along the each of the path parts on the rail, and a fixing unit that selectively protrudes from a lower surface of the movable member and is inserted into one of the fixing grooves may be provided on the movable member.

According to a multipurpose module for mobility vehicles of the present disclosure described above, by changing the position of an auxiliary device such as a seat or stand in the interior of a mobility vehicle to various positions along path parts, the convenience of using the auxiliary device can be improved, and the marketability of the mobility vehicle can be enhanced as the usability of the interior space is increased by allowing passengers to freely change the interior space of the mobility vehicle.

The effect obtained in the present disclosure is not limited to the above-mentioned effects, and other effects not mentioned above may be clearly understood by those having ordinary skill in the art from the following description.

### BRIEF DESCRIPTION OF THE DRAWINGS

FIG. 1 is a view showing a multipurpose module for mobility vehicles according to an embodiment of the present disclosure.

FIG. 2 is a schematic view showing a rail and a movable member according to an embodiment of the present disclosure.

FIG. 3 is a perspective view showing a movable member according to an embodiment of the present disclosure.

FIG. 4 is an assembly view showing a movable member according to an embodiment of the present disclosure.

FIG. 5 is a view showing the lower part of a movable member according to an embodiment of the present disclosure.

FIG. 6 is a view showing a movable member according to an embodiment of the present disclosure moving to a first path part.

FIG. 7 is a view showing a rolling part of a movable member according to an embodiment of the present disclosure in rolling motion.

FIG. 8 is a view showing a movable member according to an embodiment of the present disclosure moving to a second path part.

FIG. 9 is a view showing a rolling part of a movable member according to an embodiment of the present disclosure in sliding motion.

FIG. 10 is a view showing a movable member according to another embodiment of the present disclosure.

FIG. 11 is a view showing a movable member according to an embodiment of the present disclosure arranged on a rail.

FIG. 12 is a view showing a fixing unit of a movable member according to an embodiment of the present disclosure.

FIG. 13 is a view showing an example of application of a multipurpose module for mobility vehicles according to an embodiment of the present disclosure.

### DETAILED DESCRIPTION

In the following description of the embodiments disclosed herein, detailed descriptions of known technologies related to the present disclosure are omitted when they are deemed to obscure the essential features of the disclosed embodiments. Furthermore, the accompanying drawings are provided only to facilitate understanding of the embodiments disclosed in this specification and are not intended to limit the technical scope of the present disclosure. The spirit and scope of the present disclosure should be understood to encompass all modifications, equivalents, and substitutions that fall within the scope of the present disclosure. The present disclosure is not intended to limit the present disclosure to the described forms or specific fields of application. It is to be understood that various alternative embodiments and modifications, whether explicitly or implicitly disclosed, may be made. Those having ordinary skill in the art to which the present disclosure pertains will recognize that changes may be made to the form and details of the present disclosure without departing from the scope and spirit of the disclosure.

The present disclosure is described with reference to certain embodiments. However, as should be understood by those of ordinary skill in the art to which the present disclosure pertains, various modifications and alternative implementations of the disclosed embodiments may be made without departing from the spirit and scope of the present disclosure. Accordingly, the following description should be regarded as illustrative and is intended to teach those having ordinary skill in the art how to make and use various embodiments within the scope of the present disclosure. The forms of the disclosure illustrated and described herein are to be understood as examples only. Equivalent elements, materials, processes, or steps may be substituted for those specifically illustrated and described herein. Terms such as “including”, “comprising”, “incorporating”, “consisting of”, “having”, and “is”, as used in this specification, are intended to be interpreted in a non-limiting manner. In other words, such terms should be construed to include items, components, or elements not expressly listed. In addition, references to the singular form are to be understood as including the plural form as well, unless the context clearly dictates otherwise.

Furthermore, the various embodiments disclosed in the present specification are to be understood as illustrative and descriptive, and are not intended to limit the scope of the present disclosure. All references to “joining” (for example, “attached”, “affixed”, “coupled”, “connected”, and the like) are provided solely to aid in the understanding of the disclosure and are not intended to limit the positioning, orientation, use, or methods disclosed herein. Accordingly, references to joining are to be interpreted broadly. In addition, such references do not necessarily imply that two or more elements are directly connected to each other, unless explicitly stated otherwise. Additionally, all numerical terms or descriptors, such as “first”, “second”, “third”, “primary”, “secondary”, “major”, or any other general or ordinal terms, are to be understood solely as identifiers used to distinguish elements, configurations, variations, or modifications, and are not intended to indicate any order, priority, or preference among such elements. In other words, these terms may be used to describe various components, but the components themselves are not to be limited by such descriptors. This terminology is used solely to distinguish one element from another.

In the following description, suffixes such as “module” and “part” used in reference to components are provided solely for convenience and are used interchangeably without implying any distinct meaning or function.

When it is stated that a certain component is “connected” or “coupled” to another component, it should be understood that the connection or coupling may be direct or indirect, with other intervening components potentially present. In contrast, when a component is described as being “directly connected” or “directly coupled” to another component, it should be understood that no intervening components are present.

Additionally, the terms “unit” or “control unit” included in the name of a component are terms widely used to name a controller that controls a specific function of a vehicle, and do not mean a generic function unit. When a component, unit, controller, device, element, apparatus, or the like of the present disclosure is described as having a purpose or performing an operation, function, or the like, the component, unit, controller, device, element, apparatus, or the like should be considered herein as being “configured to” meet that purpose or to perform that operation or function. Each component, unit, controller, device, element, apparatus, and the like may separately embody or be included with a processor and a memory, such as a non-transitory computer readable media, as part of the apparatus.

Any number or variety of components in any of the configurations described herein may be included within the disclosure described herein. The components may include any combination of the features described herein and may be arranged in any of the various configurations described herein. The concepts relating to the structure and arrangement of the components disclosed herein, as well as their use and operation, may be applied to any number of embodiments in any combination, and are not limited to the specific embodiments discussed herein. Various embodiments including different features and configurations are described below with reference to the drawings.

Hereinafter, various embodiments disclosed in the present specification are described in detail with reference to the accompanying drawings. In the drawings, identical or similar components are denoted by the same reference numerals regardless of the figure in which they appear, and redundant descriptions thereof are omitted.

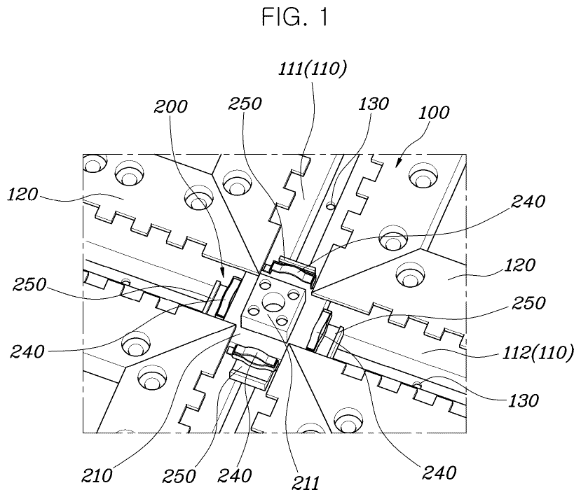

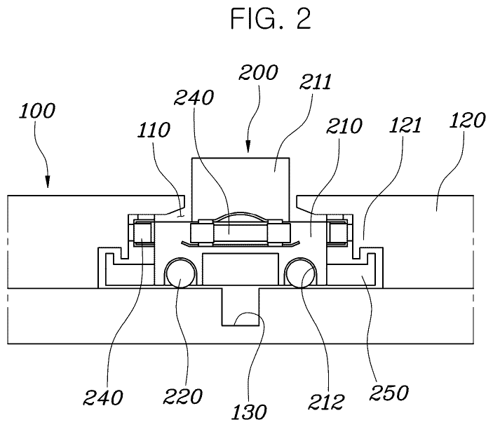

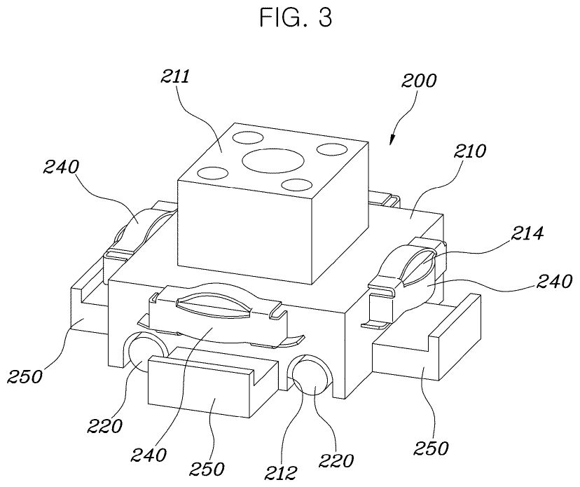

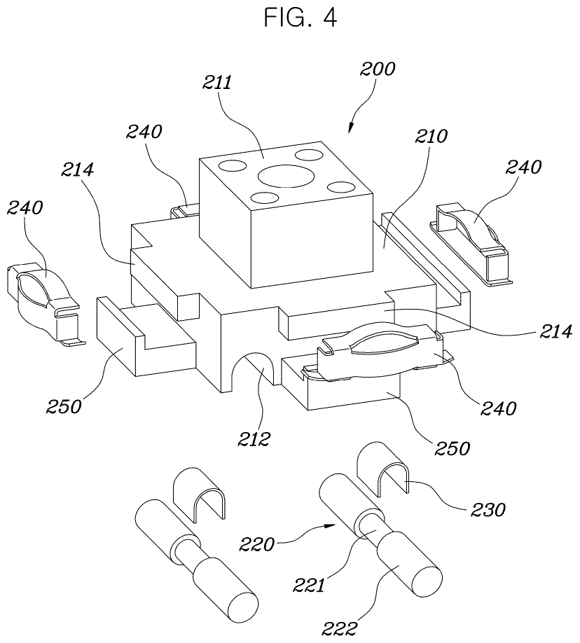

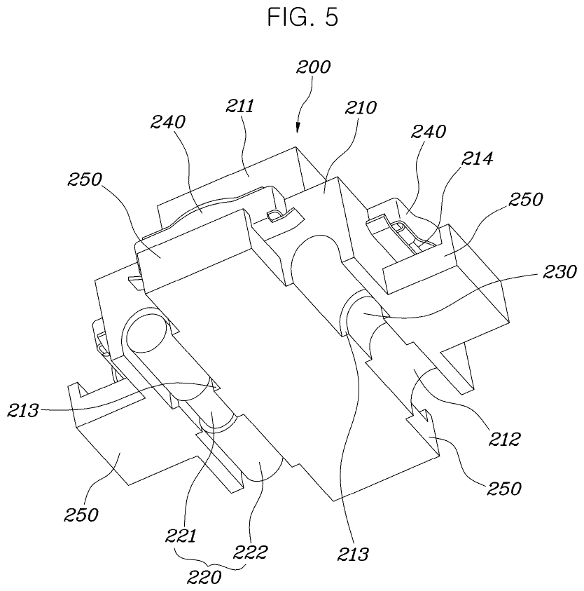

FIG. 1 is a view showing a multipurpose module for mobility vehicles according to an embodiment of the present disclosure, FIG. 2 is a schematic view showing a rail 100 and a movable member 200 according to an embodiment of the present disclosure, FIG. 3 is a perspective view showing the movable member 200 according to an embodiment of the present disclosure, FIG. 4 is an assembly view showing the movable member 200 according to an embodiment of the present disclosure, and FIG. 5 is a view showing the lower part of the movable member 200 according to an embodiment of the present disclosure.

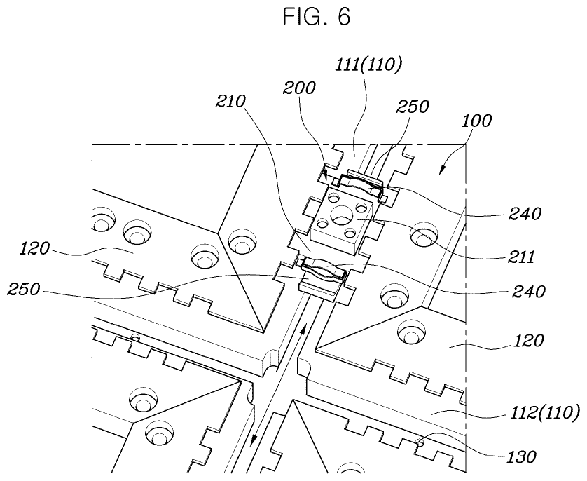

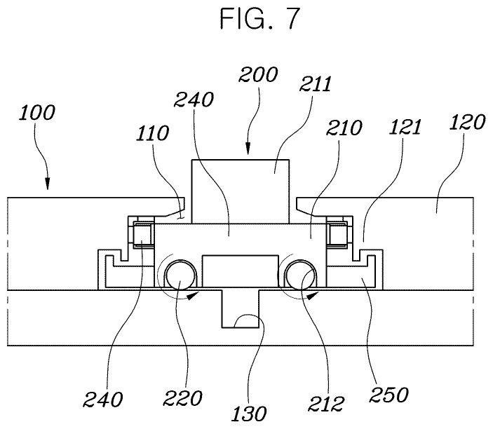

FIG. 6 is a view showing the movable member 200 according to an embodiment of the present disclosure moving to a first path part 111, and FIG. 7 is a view showing a rolling part 220 of the movable member 200 according to an embodiment of the present disclosure in rolling motion.

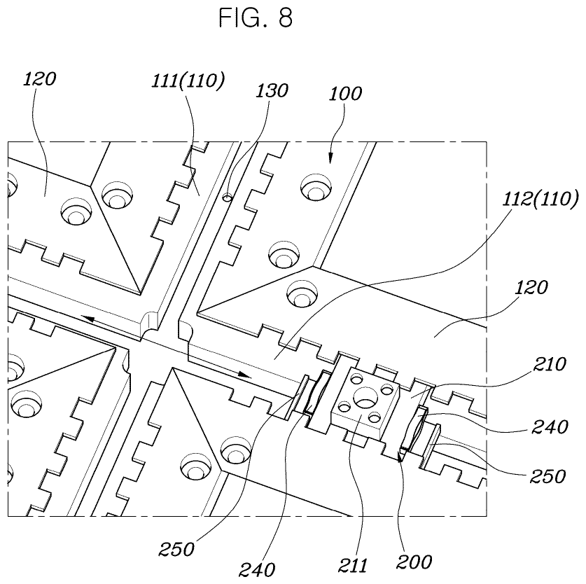

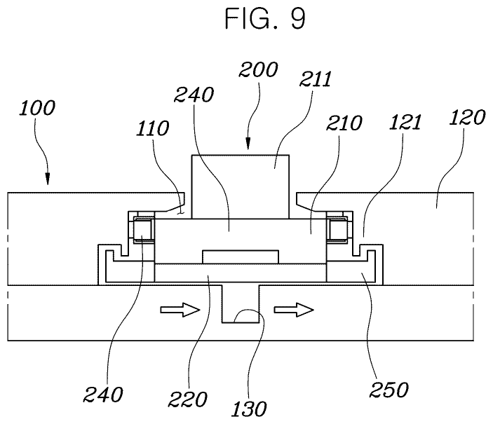

In addition, FIG. 8 is a view showing the movable member 200 according to an embodiment of the present disclosure moving to a second path part 112, and FIG. 9 is a view showing the rolling part 220 of the movable member 200 according to an embodiment of the present disclosure in sliding motion.

As shown in FIGS. 1-5, a multipurpose module for mobility vehicles according to the present disclosure may include: a rail 100 constructed such that a plurality of path parts 110 intersects at least at one point on the floor (i.e., an intersection point); and a movable member 200 on which an auxiliary device A is installed or disposed, and provided to be movable along the path parts 110, thereby changing the position of the auxiliary device A by moving along each path part 110 while passing through an intersection point of each path part 110.

A mobility vehicle can be a means of transportation that provides a space for passengers to board, and can be, for example, a vehicle.

The interior of such mobility vehicle may be provided with the auxiliary device A that provides various conveniences to passengers, including a seat, a stand, and a storage box or compartment.

According to the present disclosure, the position of the auxiliary device A may be changed as the auxiliary device A is installed on the movable member 200, and the movable member 200 moves along the rail 100.

The rail 100 may include the plurality of path parts 110 extending from or along a floor (i.e., an interior surface of a mobility vehicle), and the plurality of path parts 110 may have at least one intersection point, so that the movable member 200 can move to various positions on the floor along the path parts 110. The path parts 110 may be formed to extend by being recessed in the floor, and a mat cut along the extension line of the path parts 110 (a line along which the path parts extend) may be provided so that the recessed portion above the path parts 110 is not exposed. In addition, the rail 100 may be manufactured separately and installed on the floor at a later time.

The extension direction of individual path parts 110 may be designed in various ways depending on the interior space of the mobility vehicle.

In an embodiment according to the present disclosure, the rail 100 may include: a first path part 111 extending in one direction (a first direction); and a second path part 112 extending in a direction (a second direction) orthogonal to the first path part 111 and configured to intersect the first path part 111 at the at least one point.

The first path part 111 and the second path part 112 may be each extended in a straight line, and be extended to intersect each other at the at least one point to provide a path in which the movable member 200 may move in various directions.

In addition, since the first path part 111 and the second path part 112 may be extended orthogonally, interference between movable members 200 moving in the individual path parts 110 is avoided, and the plurality of path parts 110 may be intuitively configured to ensure ease of use.

The first path part 111 and the second path part 112 described above may be configured to extend in various forms, and additional path parts 110 may be configured to provide various paths.

In order to help understand the present disclosure, in this disclosure, the first path part 111 and the second path part 112 are assumed to extend orthogonally.

The movable member 200 is provided and configured to be movable along the path parts 110 that constitute the rail 100. The auxiliary device A is capable of being installed on the movable member 200, and the position of the auxiliary device A may be determined according to the position at which the movable member 100 moves along the path parts 110. A plurality of movable members 200 may be provided for one auxiliary device A.

The movable member 200 according to an embodiment according to the present disclosure is described in detail below. The movable member 200 may include: a body part 210 in or on which the auxiliary device A is installed; and a rolling part 220 configured to be rotatable in at least one direction at a lower portion of the body part 210.

In other words, the movable member 200 includes the body part 210 and the rolling part 220, wherein the body part 210 is formed so as to be able to move along the path parts 110 while the auxiliary device A is installed thereon. The body part 210 is provided or disposed in or on the path parts 110 of the rail 100, and the rolling part 220 is provided on the body part 210 so that the body part 210 can move along or within the path parts 110.

### In an Embodiment of the Present Disclosure,

as the path parts 110 of the rail 100 are formed to extend in a straight line and intersect, the outer shape of the body part 210 may be formed in a square shape, but the body part 210 may be formed in various shapes including a circle.

The body part 210 may be formed with a mounting part 211 that extends upwardly to be exposed from the rail 100. The auxiliary device A may be detachably installed on the mounting part 211.

The mounting part 211 extends upward from the central upper surface of the body part 210, and various connecting structures including a hole or a protrusion may be applied so that the auxiliary device A may be mounted on the mounting part 211. In addition, the mounting part 211 is exposed upward from the path parts 110 of the rail 100 (i.e., a top surface of the mounting part 211 is at a height in the vertical direction higher than a height of the path parts 110) since the mounting part 211 extends upward from the body part 210, making it easy to attach and detach the auxiliary device A. Since the auxiliary device A can be attached to and detached from the mounting part 211, various auxiliary devices A may be selectively attached to the movable member 200. For the connection between the auxiliary device A and the mounting part 211, the auxiliary device A may be mounted on or separated from the mounting part 211 by using various joining methods, including fitting and screw fastening.

Referring to FIG. 4 and FIG. 5, in the lower portion of the body part 210, a recessed groove part 212 is formed to extend in a direction in which one of the path parts 110 extends, and the rolling part 220 is formed in a cylindrical shape and is secured in the groove part 212 to support the body part 210 from the floor.

The groove part 212 extending in a straight line is formed at the lower portion of the body part 210. The groove part 212 (or groove parts 212) may be arranged and spaced apart from opposite ends of the lower surface of the body part 210. The number of groove parts 212 may be set or determined by considering the support force of the body part 210 by means of the rolling part 220 or the force for moving the body part 210. The groove part 212 may be formed to extend in a direction that matches the direction in which one of the path parts 110 extends when extending in a straight line. In other words, a longitudinal direction of the groove part 212 corresponds to a longitudinal direction of one of the path parts 110.

The rolling part 220 is formed in a cylindrical shape and configured to be inserted into a groove part 212. The body part 210 is configured to move as the rolling part 220 rotates. In the case of the rolling part 220, when a plurality of groove parts 212 is provided, the number of rolling parts 220 is set such that a respective rolling part 220 is inserted into each groove part 212. When the rolling part 220 is inserted into a corresponding groove part 212, a portion thereof is exposed downward and may be supported on the floor. In other words, when inserted into a groove part 212, a portion of the rolling part 220 extends outward from the groove part 212 toward the floor.

Due to this, the rolling part 220 may slide or rotate according to the movement direction of the movable member 200 during the process of moving the movable member 200.

In other words, as the groove part 212 extends in the direction in which one of the path parts 110 is extended, and the rolling part 220 is secured to the groove part 212, the rolling part 220 may slide when the body part 210 moves along one of the path parts 110 and the rolling part 220 may roll when the body part 210 moves along another of the path parts 110.

For example, as shown in FIG. 6, in a state where path part 110 include the first path part 111 and the second path part 112, when the groove part 212 of the movable member 200 is formed to extend in the direction in which the second path part 112 extends, which is orthogonal to the extension direction of the first path part 111, as the movable member 200 moves along the first path part 111, the rolling part 220 may rotate on the floor.

As shown in FIG. 7, since the direction in which the movable member 200 moves and the direction of rotation of the rolling part 220 coincide, the movable member 200 may be moved by the rotational movement of the rolling part 220.

As shown in FIG. 8, when the movable member 200 moves along the second path part 112, the rolling part 220 may slide on the floor. In other words, as shown in FIG. 9, as the direction in which the rolling part 220 extends and the direction of the second path part 112 coincide, the movable member 200 moves as the rolling part 220 slides while in contact with the floor. In this case, the rolling part 220 is in a state of point contact with the floor as the cross section thereof is circular, and thus the rolling part 220 may slide with reduced friction.

### As Such, the Rolling Part 220 According to an

embodiment may rotate in the path parts 110 in one direction and may slide in the path parts 110 in another direction, so that the movable member 200 can move in each of the plurality of path parts 110.

As shown in FIG. 4, a bearing part 230 may be provided in the groove part 212, so that the rolling part 220 may be rotatably mounted in the groove part 212 via the bearing part 230.

The bearing part 230 is formed to be curved along the inner surface of the groove part 212 and is formed in an upside down “U” (“∩”) shape as a portion of the inner surface thereof is circular. In this way, the bearing part 230 wraps around a portion of the rolling part 220 while being seated in the groove part 212 and enables the rolling part 220 to rotate. The bearing part 230 may have a low-friction coating on the surface thereof surrounding the rolling part 220, and the bearing part 230 itself may be made of a low-friction material.

As shown in FIG. 5, a portion of the groove part 212 protrudes inward to form a fixing part 213, and the bearing part 230 is fitted into the fixing part 213 with the outer surface thereof in contact with the groove part 212, and the inner surface thereof may be formed so that the rolling part 220 is inserted.

In this way, in the groove part 212, the fixing part 213 protrudes inward from the bottom, and the bearing part 230 may be formed so that the upper end of the outer surface thereof is caught by the fixing part 213. Due to this, the bearing part 230 is prevented from being separated from the groove part 212 as the outer surface thereof is caught by the fixing part 213 when inserted into the groove part 212. In the case of the fixing part 213, a pair of fixing parts 213 may be formed in the groove part 212, so that the bearing part 230 may be stably fixed to the pair of fixing parts 213.

The bearing part 230 is formed so that the inner surface thereof surrounds a portion of the outer surface of the rolling part 220, thereby regulating the position of the rolling part 220 and allowing the rolling part 220 to rotate smoothly. The bearing part 230 may be formed in a size that is not exposed from the groove part 212 when inserted into the groove part 212.

In this way, as the bearing part 230 is provided in the groove part 212, the rolling part 220 may include: a contact part 221 that comes into contact with the inner surface of the bearing part 230; and a support part 222 that extends from the contact part 221 in the longitudinal direction of the groove part 212 and is supported on the floor.

As shown in FIGS. 4 and 5, the rolling part 220 may include the central contact part 221 and the support part 222 extending to opposite sides of the contact part 221. In other words, the rolling part 220 may include two support parts 222, one on each side of the central contact part 221. Both the contact part 221 and the support parts 222 may have a circular cross-section.

The contact part 221 may be inserted into the bearing part 230 and rotatably contacts the inner surface of the bearing part 230. The support part(s) 222 may be in contact with the floor and may rotate or slide on the floor. In this case, the support part(s) 222 may be configured to be in contact with both the inner surface and the bottom of the groove part 212 to ensure structural stability.

### The Rolling Part 220 According to Another

embodiment may include a ball bearing, and a portion thereof may be inserted into the lower portion of the body part 210 to support the body part 210 from the floor.

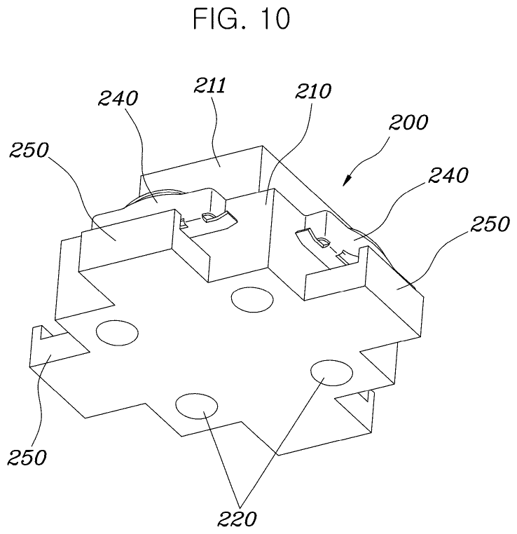

FIG. 10 is a view showing the movable member 200 according to another embodiment of the present disclosure, in which the rolling part 220 may include a circular ball bearing, and a groove may be formed in the lower portion of the body part 210 so that a portion of the rolling part 220 may be inserted therein. The rolling part 220 including the ball bearing in this way may be provided in plural numbers at the lower portion of the body part 210, and may be spaced apart from each other at a certain interval on the lower surface of the body part 210 to ensure a uniform load bearing capacity.

As such, by configuring the rolling part 220 according to another embodiment with a ball bearing that can rotate 360°in all directions, the movable member 200 may be moved using rotational motion in each path part 110 of the rail 100.

The above-described rolling part 220 may be applied as various examples, and which example is applied may be determined by considering a variety of factors including the support load of the auxiliary device A and the operability when moving the movable member 200.

In this disclosure, each path part 110 may include a pair of wall parts 120, and the wall parts 120 are spaced apart from each other to create a path through which the movable member 200 can move between the wall parts 120.

As shown in FIG. 1 and FIG. 2, each path part 110 may include the wall parts 120 arranged to face each other, and the space between the wall parts 120 forms a path through which the movable member 200 can move. The wall parts 120 are fixed to the floor, and a panel constituting the floor in the interior of the mobility vehicle may be joined to the upper surfaces of the wall parts 120.

In this case, the movable member 200 may be provided with a plurality of damping parts 240 on the peripheral surface thereof, and at least one damping part 240 may come into contact with one of the wall parts 120 of the path part 110.

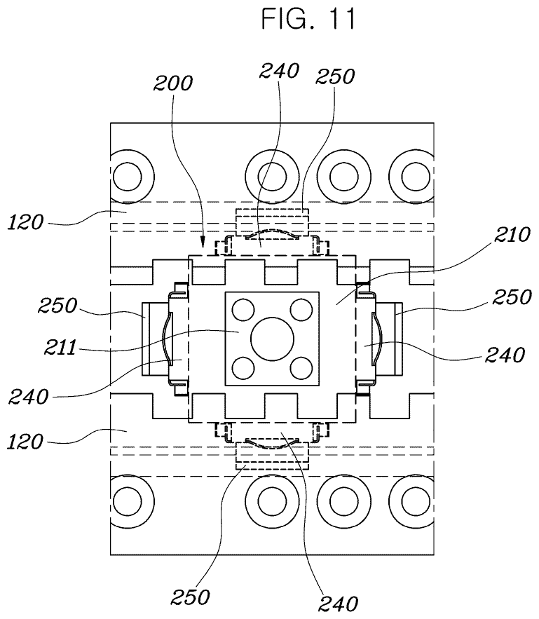

As shown in at least FIG. 2, FIG. 4, and FIG. 11, as the damping parts 240 are arranged to be spaced apart from each other on the peripheral surface of the movable member 200, the damping parts 240 are interposed between the movable member 200 and the wall parts 120, so that a free gap between the movable member 200 and the wall parts 120 may be absorbed and the impact may be attenuated.

In this disclosure, the path part 110 may be extended such that the first path part 111 and the second path part 112 are perpendicular to each other, and thus the damping parts 240 may be spaced apart at 90° intervals on the peripheral surface of the movable member 200. The damping parts 240 are not limited thereto, and the number and installation location may be changed depending on the path part 110.

The movable member 200 is provided with a plurality of fastening parts 214 along the peripheral surface thereof. The damping part 240 is mounted on the fastening part 214, and the portion of the damping part 240 that comes into contact with the wall part 120 may be made to be elastically deformable.

The fastening part 214 is formed to protrude from the peripheral surface of the movable member 200, and the damping part 240 is formed to be inserted into or onto the fastening part 214 and may be fixed to the fastening part 214. In particular, the damping part 240 may be formed to be elastically deformable. However, because the damping part 240 may hinder the movement of the movable member 200 if the damping part 240 is made of a material with high friction, such as rubber, the damping part 240 may be made to generate elastic force through deformation of the shape thereof. For example, as shown in FIG. 4, the damping part 240 may be formed in a curved and protruding shape at a portion that comes into contact with the wall part 120, and the contact area with the wall part 120 may be reduced by the curved shape. In this way, the impact may be attenuated by the shape deformation. In addition, the damping part 240 may easily fill the free gap between the body part 210 and the wall part 120 by the curved and protruding shape.

### As Such, by Providing the Damping Parts 240 on

the movable member 200, when the movable member 200 moves along the path part 110, the damping parts 240 form an elastically supporting structure on the wall parts 120 of the path part 110, which stabilizes the structure, and the vibration transmitted through the wall parts 120 is canceled out, thereby preventing discomfort when using the auxiliary device A.

A catch part 121 protruding along a path of the movable member 200 is provided on the wall part 120 of the path part 110, and a plurality of anti-separation parts 250 is formed on the peripheral surface of the movable member 200, so that at least one anti-separation part 250 may be matched with the catch part 121.

As shown in FIG. 2, the catch part 121 protrudes inwardly from the wall part 120, and the anti-separation part 250 of the movable member 200 is formed to extend toward the wall part 120 so as to be caught on the catch part 121, preventing the movable member 200 from separating from the path part 110.

The anti-separation part 250 may be provided at the lowest portion of the body part 210 so as not to interfere with the damping part 240. The catch part 121 of the wall part 120 is arranged above the anti-separation part 250 to restrict the anti-separation part 250 from moving upward.

In addition, the catch part 121 may be shaped to be bent downwardly from the wall part 120, and the anti-separation part 250 may be shaped to be bent upwardly after extending from the movable member 200 to below the catch part 121.

Due to this, the catch part 121 of the wall part 120 and the anti-separation part 250 of the movable member 200 are aligned in the vertical direction so that the movable member 200 is restricted from moving upward. As the end of the catch part 121 and the end of the anti-separation part 250 are shaped to be bent and interlocked, the movable member 200 may be maintained in a fixed position in the path part 110.

A plurality of fixing grooves 130 is arranged spaced apart along each path part 110 on the rail 100, and a fixing unit 260 that is configured to selectively protrude from the lower surface of the movable member 200 and be inserted into the fixing groove 130 may be provided on the movable member 200.

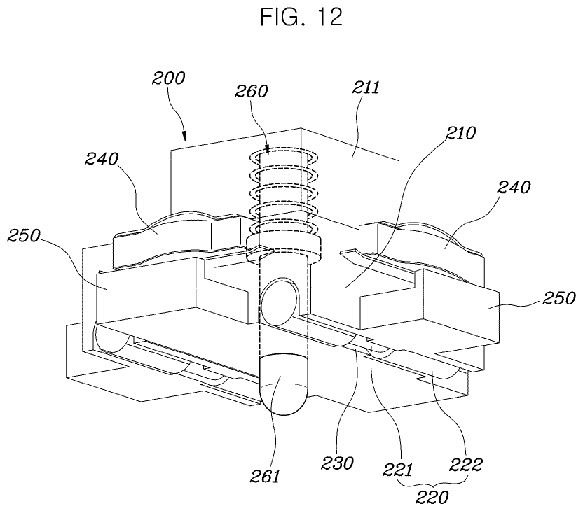

As shown in FIG. 12, the fixing unit 260 is installed on the movable member 200, and a fixing pin 261 protruding downward from the movable member 200 may be provided. The fixing pin 261 may protrude downward from the movable member 200 while moving linearly up and down from the movable member 200, and a power transmission means such as an electromagnet or an actuator may be provided for selective protrusion of the fixing pin 261. Although a device for controlling the position of the fixing pin 261 in the fixing unit 260 of the present disclosure is not illustrated in the drawing, the change in the movement position of the fixing pin 261 by either an electromagnet or an actuator is a known technology in the relevant field and is therefore omitted.

As shown in FIG. 1, in the path part 110, the fixing grooves 130 are formed at regular intervals, so that the position at which the movable member 200 is fixed may be set in various ways. In this way, when the movable member 200 moves in the path part 110 and the position of the movable member 200 is determined, the position of the movable member 200 may be fixed by inserting the fixing pin 261 of the fixing unit 260 into the fixing groove 130. The fixing unit 260 may be configured to be operated directly by a passenger or to determine whether to operate upon input of a command under the control of a controller.

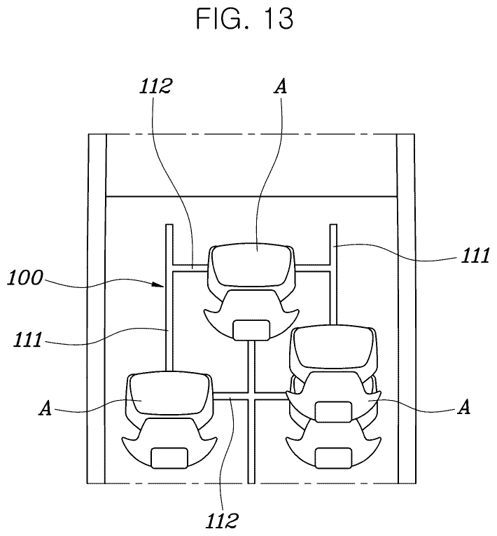

The multipurpose module for mobility vehicle according to an embodiment of the present disclosure described above may be applied as an example shown in FIG. 13. In other words, in the interior of the mobility vehicle, a plurality of seats constituting the auxiliary device A is each installed on a respective movable member 200, and the auxiliary device A is moved along the path part 110 together with the movable member 200, thereby allowing the position of the auxiliary device A to be changed to various positions.

According to the multipurpose module for a mobility vehicle of the present disclosure, by changing the position of an auxiliary device such as a seat or stand in the interior of the mobility vehicle to various positions along path parts, the convenience of using the auxiliary device may be improved, and the marketability of the mobility vehicle may be enhanced as the usability of the interior space is increased by allowing passengers to freely change the interior space of the mobility vehicle.

Although the present disclosure was provided above in relation to specific embodiments shown in the drawings, it is apparent to those having ordinary skill in the art that the present disclosure may be changed and modified in various ways without departing from the scope of the present disclosure, which is described in the following claims.

What is claimed is:

1. A multipurpose module for mobility vehicles, the module comprising:
a rail constructed such that a plurality of path parts intersects at least at one point on a floor; and
a movable member on which an auxiliary device is disposed, the movable member configured to be movable along the path parts, thereby changing a position of the auxiliary device by moving along each of the path parts while passing through an intersection point of the path parts.

2. The module of claim 1, wherein the rail comprises:
a first path part extending in a first direction; and
a second path part extending in a second direction orthogonal to the first path part and configured to intersect the first path part at the one point on the floor.

3. The module of claim 1, wherein the movable member comprises:
a body part on which the auxiliary device is disposed; and
a rolling part configured to be rotatable in at least one direction at a lower portion of the body part.

4. The module of claim 3, wherein the body part includes a mounting part that extends upwardly from the body part to be exposed from the rail, and wherein the auxiliary device is configured to be detachably installed on the mounting part.

5. The module of claim 3, wherein in the lower portion of the body part, a recessed groove part is formed to extend in a direction in which one of the path parts extends, and
the rolling part is formed in a cylindrical shape and is secured in the groove part to support the body part from the floor.

6. The module of claim 5, wherein the rolling part is configured to be seated in the groove part so that the rolling part slides when the body part moves along one of the path parts and rolls when the body part moves along another of the path parts.

7. The module of claim 5, wherein a bearing part is provided in the groove part, and the rolling part is configured to be rotatably seated in the groove part via the bearing part.

8. The module of claim 7, wherein a portion of the groove part protrudes inward to form a fixing part, and
the bearing part is fitted into the fixing part with an outer surface thereof in contact with the groove part, and an inner surface thereof is formed so that the rolling part is insertable therein.

9. The module of claim 7, wherein the bearing part is formed to be curved along an inner surface of the groove part, and a portion of an inner surface of the bearing part is semi-circular, and
the rolling part includes a contact part configured to come into contact with the inner surface of the bearing part and a support part that extends from the contact part in a longitudinal direction of the groove part and is configured to be supported on the floor.

10. The module of claim 3, wherein the rolling part includes a ball bearing, and a portion thereof is inserted into the lower portion of the body part to rotatably support the body part from the floor.

11. The module of claim 1, wherein each of the path parts includes a pair of wall parts, and the wall parts form a path through which the movable member is moveable.

12. The module of claim 11, wherein the movable member includes a plurality of damping parts on a peripheral surface thereof, and at least one damping part is configured to come into contact with one of the wall parts of the each of the path parts.

13. The module of claim 12, wherein the movable member includes a plurality of fastening parts along the peripheral surface thereof, and
the damping parts are respectively mounted on the fastening parts, and a portion of each of the damping parts that comes into contact with the one of the wall parts is elastically deformable.

14. The module of claim 11, wherein a catch part protruding along a path of the movable member is provided on each of the wall parts of the each of the path parts, and
a plurality of anti-separation parts is provided on a peripheral surface of the movable member, so that at least one anti-separation part is matched with a respective catch part.

15. The module of claim 14, wherein the catch part has a shape that is bent downward from the each of the wall parts, and
each of the anti-separation parts has a shape that extends outward from the movable member to below the catch part and extends upward at an end thereof.

16. The module of claim 1, wherein a plurality of fixing grooves is spaced apart along each of the path parts on the rail, and
wherein the movable member includes a fixing unit that is configured to selectively protrude from a lower surface of the movable member to be inserted into one of the fixing grooves.
